(19) United States
(12) Patent Application Publication
(10) Pub. No.: US 2026/0359670 A1
(43) Pub. Date: Nov. 12, 2026

(54) METHODS, SYSTEMS, AND APPARATUSES FOR IMPROVED STRUCTURE-AWARE DOCUMENT CHUNKING

(71) Applicant: QlikTech International AB, Lund (SE)

(72) Inventors: Tessa McNeil, King of Prussia, PA (US); Zeeshan Mughal, King of Prussia, PA (US); Anant Sapatnekar, King of Prussia, PA (US)

(21) Appl. No.: 19/675,025

(22) Filed: May 12, 2026

Related U.S. Application Data
(60) Provisional application No. 63/804,401, filed on May 12, 2025.

(51) Int. Cl. G06N 5/022

(52) U.S. Cl. CPC G06N 5/022

(57) ABSTRACT

The present disclosure relates to methods and systems for structure-aware document chunking. A method may comprise receiving a source document. The method may comprise generating, based on the source document, a structured representation. The structured representation may identify a hierarchy of sections and at least one structured element within the source document. The method may comprise determining, based on the hierarchy of sections in the structured representation, a plurality of candidate chunk boundaries. The method may comprise generating, based on the plurality of candidate chunk boundaries, a plurality of chunks. The at least one structured element may be preserved within a single chunk of the plurality of chunks. The method may comprise causing the plurality of chunks to be stored with associated metadata and embedding vectors in a knowledge base.

### CROSS-REFERENCE TO RELATED PATENT APPLICATION

This application claims priority to U.S. Prov. App. No. 63/804,401, filed on May 12, 2025, the entirety of which is incorporated by reference herein.

### BACKGROUND

Retrieval-augmented generation systems combine large language models with external knowledge bases to ground responses in source materials. Such knowledge bases store text fragments derived from documents, manuals, transcripts, or other sources. Conventional approaches divide documents according to fixed character or token counts. Fixed-size chunking may ignore document structure and semantics. A heading may be separated from paragraphs it introduces, or a table may be divided without preserving header information. These issues may reduce retrieval quality and answer accuracy. There remains a need for document-processing techniques with improved awareness of document structure. These and other considerations are discussed herein.

### SUMMARY

It is to be understood that both the following general description and the following detailed description are exemplary and explanatory only and are not restrictive. The present disclosure relates to methods and systems for structure-aware document processing, such as in retrieval-augmented generation environments. Various aspects may involve receiving source documents and generating structured representations that identify hierarchical relationships and structured elements within the documents. Candidate chunk boundaries may be determined based on the structured representations, and chunks may be generated while preserving structured elements within individual chunks. The chunks may be stored with associated metadata and embedding vectors in a knowledge base. In some aspects, tables exceeding size thresholds may be divided into multiple table chunks, each including replicated header information. Chunking policies may be adaptively selected based on document characteristics. Chunks may be enriched with summaries, titles, synonyms, or domain-specific labels. Metadata may include document identifiers, section identifiers, page ranges, element types, policy identifiers, version identifiers, or access-control labels. Structure-preservation constraints may be applied to avoid splitting structured elements. Boundary types may be prioritized such that section breaks receive higher priority than paragraph breaks. Other examples are possible as well.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A illustrates a block diagram of an example system.

FIG. 1B illustrates a block diagram of an example system for transforming data.

FIG. 2 illustrates an example user interface for presenting answers to natural language queries.

FIG. 3 illustrates a flowchart of a method for structure-aware document chunking.

FIG. 4 illustrates a flowchart of a method for hybrid contextual retrieval.

FIG. 5 illustrates a flowchart of a method for grounded response generation.

FIG. 6 illustrates a block diagram of an example system.

FIG. 7 illustrates a flowchart of a method for structure-aware document chunking.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

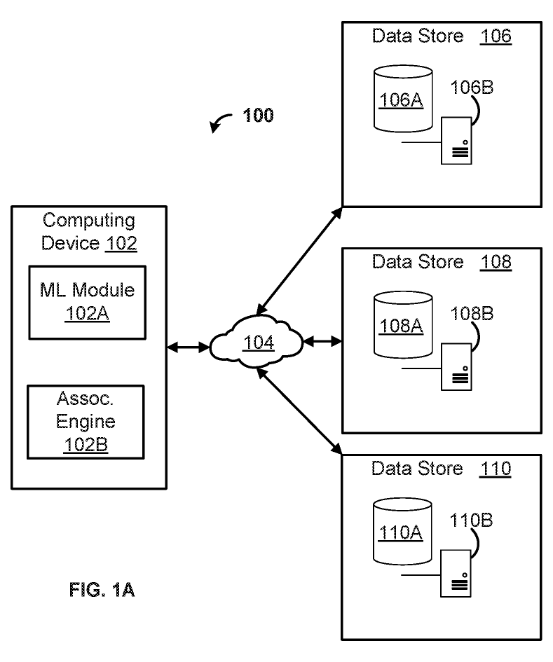

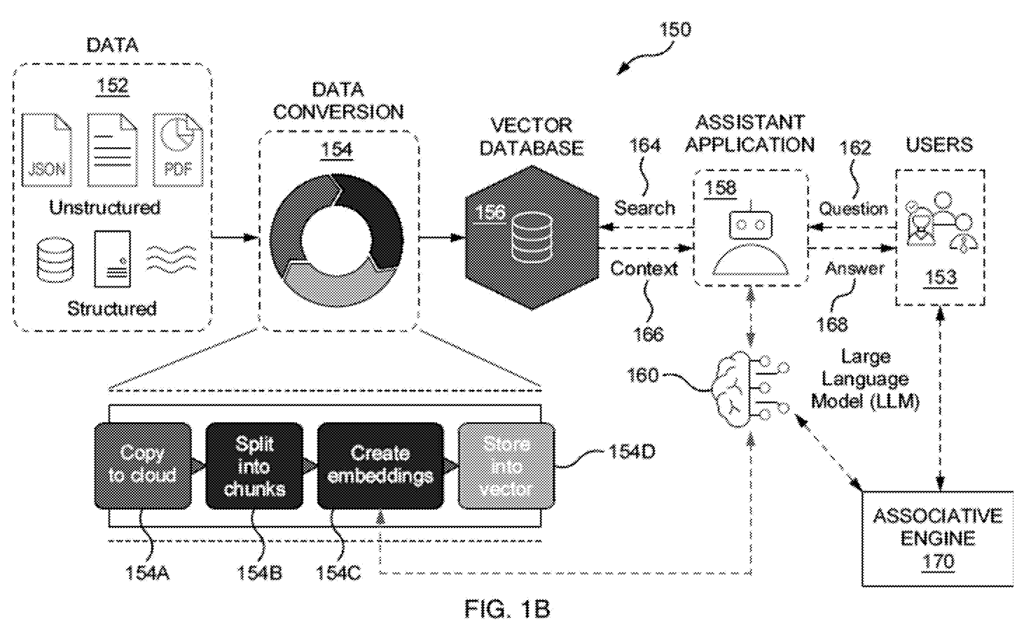

Turning now to FIG. 1A, a block diagram of an example system 100 is shown. The system 100 may include a computing device 102 and a plurality of data stores 106B, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. In some aspects, the ML module 102A may support document parsing, structure-aware chunking, and embedding generation for retrieval-augmented generation (RAG) systems. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide near-instantaneous calculation of aggregates, selections, and filters as further described herein.

Each of the plurality of data stores 106B, 108, 110 may comprise one or more data storage mechanisms, such as a relational database, a cloud data warehouse, an object store, a search index, a vector database, an application repository, a file system, a software-as-a-service platform, an in-memory data store, a log, or any other data storage repository configured for a retrieval interface. The databases may store structured and unstructured source information used to generate document chunks and embeddings for RAG systems. As used herein, the term “chunk” or “chunks” may refer to a unit of text or other serialized content derived from a source document and intended to be independently indexed, retrieved, or supplied as context to a language model. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may include one or more local-area networks, wide-area networks, cloud networks, virtual private networks, optical fiber networks, cellular networks, wireless networks, or combinations thereof. The network 104 may support secure connectivity to source systems, data connections, scheduled refresh operations, event-driven triggers, real-time application programming interfaces, and machine-to-machine communications. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data, technical documentation, reference materials, narrative documents, and other source content suitable for chunking and embedding. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a data analytics platform, a data warehouse, a customer relationship management system, or other types of systems. This integration may allow the system 100 to access additional data, provide more comprehensive insights, or offer additional features to the users. In some aspects, the system 100 environment may include containerized services, orchestration platforms, serverless functions, message queues, streaming systems, or specialized hardware accelerators such as graphics processing units, tensor processors, or inference accelerators. The disclosed methods may be deployed in a multitenant cloud environment, a private cloud, an on-premises installation, or a hybrid environment.

As an example, turning now to FIG. 1B, an example system 150 is shown. The system 150 may comprise one or more components of the system 100, as further described herein. That is, the capabilities of the system 150 as described herein also apply to the system 100, as the two systems may share – or may each comprise – each described component, resource, device, etc., that performs each of the actions described herein (and potentially not shown). As shown in FIG. 1B, the system 150 may further comprise an associative engine 170. The associative engine 170 may correspond to the AE module 102B of the computing device 102 shown in FIG. 1A. The associative engine 170 may store one or more data models in-memory and manage associations between data elements, providing near-instantaneous calculation of aggregates, selections, and filters.

In some aspects, the associative engine 170 may implement associative selection propagation. When a user 153 makes a selection in an application, the associative engine 170 may instantly perform logical inference across an entire data model, determining what is possible, what is related, and what is not. Every visualization, every number, and every data point in an entire application may update simultaneously to reflect a new context. The associative engine 170 may provide deterministic calculations such that the same query run multiple times returns the same result. This deterministic behavior may be independent of any large language model processing, such as processing by the LLM 160. The associative engine 170 may reveal not just “what is” but also “what is not” by identifying excluded values that are not related to a current context.

At its core, the associative engine 170 (which may correspond to the AE module 102B of the computing device 102 shown in FIG. 1A) may perform a transformation during data loading. Instead of storing data as traditional rows and columns, the associative engine 170 may create two distinct structures: data tables and symbol tables. Symbol tables may contain one row per distinct value for each field, acting as lookup tables. The actual data tables may contain the same structure as a traditional database, but instead of data, they may contain only bit-stuffed pointers that are indices pointing back to the symbol tables. The bit-stuffed pointers may be compressed, using only the exact number of bits needed to represent the distinct values in each field. If a field has four distinct values, the pointer may be only two bits long. If a field has 256 distinct values, the pointer may use eight bits. This bit-stuffing may create compression while maintaining fidelity. In the associative engine 170, columns may not be typed in the manner of a regular database. Instead, each cell may be typed, using only the memory needed.

The associative engine 170 may maintain state vectors. The state vectors may be binary arrays that track the status of every data point and field value in an application. When selections are made by the user 153, the state vectors may instantly update to reflect which field values are selected, possible, alternative, or excluded, which records in data tables are included in a current context, which calculations need to be updated, and what relationships exist in a current state. This state management system may enable the associative engine 170 to maintain global context across an entire application while supporting performance even with complex selections and large datasets stored in the data stores 106, 108, 110.

For calculations and visualizations, the associative engine 170 may use hypercubes. Hypercubes may be dynamic, multi-dimensional data structures that organize information for analytical computation. Hypercubes may handle complex aggregations across multiple dimensions simultaneously. Hypercubes may be created on-demand based on specific analytical needs, may handle millions of data points, and may be optimized for the types of calculations that drive analytics. The associative engine 170 may use logical inference before any calculations occur to determine which data is relevant to current selections. This logical inference may happen virtually instantaneously because there is no number crunching involved, just logical evaluation of relationships. Once logical inference determines the relevant data set, calculation engines may compute analytics in real-time using advanced techniques including hypercubes and multithreading.

The associative engine 170 may excel in artificial intelligence scenarios because context retention may allow the system 100 to build complex reasoning chains, high-speed calculation may support rapid hypothesis testing, complete data access may ensure AI models (e.g., the ML module 102A shown in FIG. 1A) have full information, relationship visibility may help AI understand data connections, and governed calculations may provide trustworthy results for automated decisions. The associative engine 170 may retain context across multiple questions 162, refining and recontextualizing after every interaction.

The technical improvements provided by the associative engine 170 may address specific technical problems in the field of data analytics. Traditional analytics tools may create tunnel vision where a user 153 writes a query, gets a result set, and sees only what matches specific criteria, while everything else including context, relationships, and the broader story disappears. Traditional approaches may result in data being left behind because SQL joins force selection of primary and secondary data sources, exploration being restricted to pre-built reports and dashboards, questions 162 needing to be anticipated in advance making discovery nearly impossible, performance suffering because each new question requires hitting the database again, and context being lost because related information does not stay connected. The associative engine 170 may provide a technical solution to these technical problems by maintaining global context across an entire application, performing deterministic calculations that are traceable and reproducible, and enabling exploration without requiring predefined queries or reports. The in-memory data structures, bit-stuffed pointers, state vectors, and hypercube calculations described herein represent specific technical implementations that improve the functioning of computer systems (e.g., the computing device 102 of the system 100 shown in FIG. 1A) for data analytics.

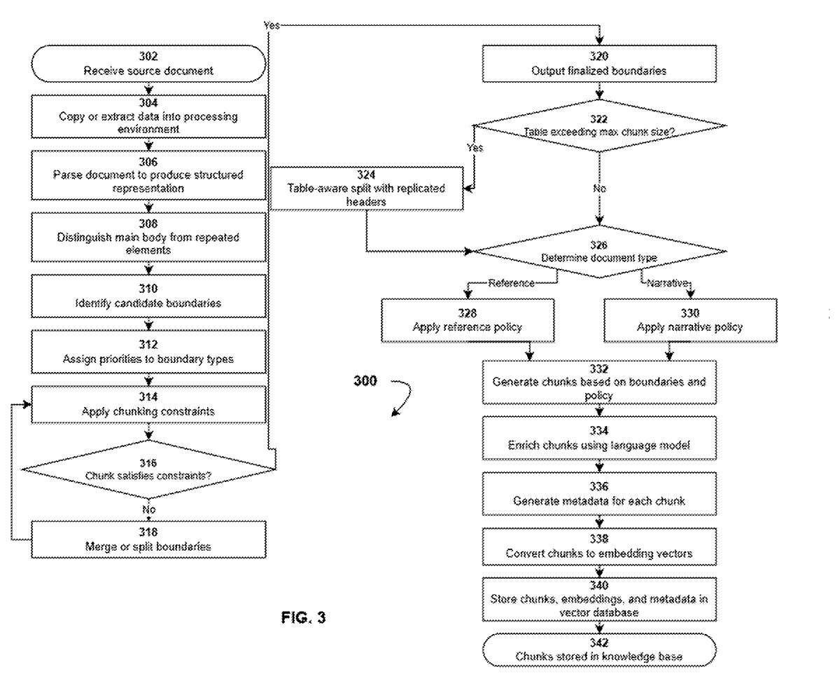

The system 150 may be utilized to transform source documents into chunks and embeddings suitable for retrieval-augmented generation, as further described with reference to FIGS. 3-5. For example, the system 150 may be utilized to transform both structured and unstructured enterprise content into machine-consumable representations. Structured content may include analytics applications, dashboards, business logic, logical models, master measures, master dimensions, field descriptions, bookmarks, stories, expressions, reusable visual assets, security rules, application metadata, data models, and semantic objects associated with one or more analytical applications. Unstructured content may include documents, presentations, HTML files, text files, portable document format files, mail archives, transcripts, tickets, knowledge articles, support records, code repositories, media transcripts, and other file-based content. A “structured element” may refer to an identifiable document component such as a section, subsection, paragraph, list, table, figure, caption, header, footer, or another element having semantic or layout significance within a source document.

The data 152 may be split into manageable chunks in a data conversion process 154. At step 154A, the data 152 may be copied, linked, or otherwise registered for indexing. Source content may be registered without requiring the entire underlying source content to be persisted in the same environment as the assistant application 158. Source materials may be refreshed manually, on a schedule, based on deltas, in response to events, or according to other synchronization policies. At step 154B, the data 152 may be split into chunks (e.g., portions of text data). Chunking may be performed by a chunking module(s), which may reside at the computing device 102, one or more of the plurality of data stores 106, 108, 110, one or more of the databases 106A, 108A, 110A, and/or at one or more of the servers 106B, 108B, 110B. In some aspects, step 154B may implement structure-aware chunking techniques that preserve document structure such as sections, paragraphs, tables, and headings, as further described with reference to FIG. 3.

Chunking may be performed by the chunking module(s) differently for different source types. A document may be segmented by sentence, paragraph, heading, or semantic boundary. A transcript may be segmented by speaker turn or time interval. An analytical application may be segmented according to measures, dimensions, master items, dashboard objects, sheets, or semantic objects. A load script or expression may be segmented according to script block, transformation step, or expression boundary. Chunk sizes may vary according to complexity, token budget, expected retrieval granularity, or computational resources. In some aspects, when a table exceeds a maximum chunk size, the chunking module may divide the table into multiple table chunks, each including a subset of rows and a replicated copy of one or more header rows so that each resulting table chunk remains interpretable in isolation.

Once the data is split into chunks, each chunk may be converted into an embedding at step 154C. As used herein, the term “embedding vector” or “embedding” may refer to a dense numerical representation of text or other content, typically expressed as a fixed-length array of floating-point values, that captures semantic meaning and enables similarity-based retrieval operations. Embeddings may be created using one or more machine-learning models, such as large language models, transformer models, recurrent neural networks, convolutional neural networks, sentence-embedding models, multimodal models, autoencoders, or dimensionality-reduction methods. Different embedding models may be used for different source types. The system 150 may generate separate representations for raw source text, curated master items, synonyms, descriptions, and logical-model entities, and may assign different weights to such representations during subsequent retrieval. For example, embeddings associated with curated master items may be weighted more heavily than embeddings associated with raw source text during retrieval operations. In some aspects, chunks may be enriched prior to embedding by generating, using a language model, a summary, title, synonyms, related terms, or domain-specific labels, as further described with reference to FIG. 3.

In some examples, at step 154C, each chunk may be converted into an embedding via LLM 160 in FIG. 1B (e.g., resident at and/or within the control of the ML module 102A). Each embedding may comprise a numerical representation of the corresponding chunk of the data 152 that may be consumed/used by an LLM(s) (e.g., by the LLM 160). Traditional word embedding models like Word2Vec, GloVe (Global Vectors for Word Representation), or FastText can also be used to generate vector representations of words or phrases. The choice of model depends on factors such as the nature of the data, the specific requirements of the task, and the available computational resources.

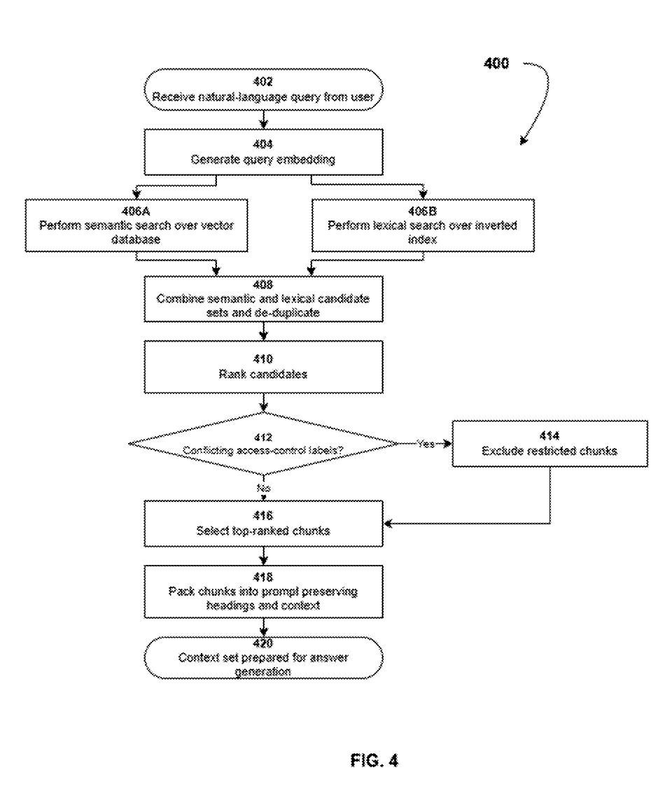

At step 154D, the embeddings may be stored in a vector database 156 (e.g., resident at and/or controlled by any of the data stores 106, 108, 110). The vector database 156 may semantically index the content and maintain references back to original sources. As used herein, the term “knowledge base” may refer to any repository, index, or combination of repositories storing chunk text, embeddings, and metadata for retrieval, and may include vector databases, lexical indices, graph stores, or other retrieval backends. The vector database 156 may store metadata such as access permissions, source type, source timestamp, indexed date, tenant or workspace identifier, application identifier, object identifier, semantic tags, ranking weights, document identifier, section identifier, page range, element type, policy identifier, or version identifier. The metadata may support retrieval, filtering, explainability, or auditing. The vector database 156 may be used in combination with a re-ranking service, a keyword index, a graph traversal engine, or a rules engine to improve retrieval quality, as further described with reference to FIG. 4.

In some aspects, the system 150 may maintain separate or partially separate indexes for structured and unstructured data while still supporting hybrid retrieval. A structured-application index may emphasize business logic, measures, dimensions, master items, and visual objects. An unstructured knowledge-base index may emphasize document passages, article fragments, ticket histories, or transcript excerpts. In response to a given question, the system 150 may retrieve from one index, the other index, or both, and may merge or reconcile the resulting context based on confidence, permissions, ranking scores, or answerability criteria. Curated semantic artifacts such as master measures, master dimensions, or business-logic entities may be weighted more heavily than raw source fields during question interpretation or result ranking to reduce ambiguity and increase answer fidelity. Other examples are possible as well.

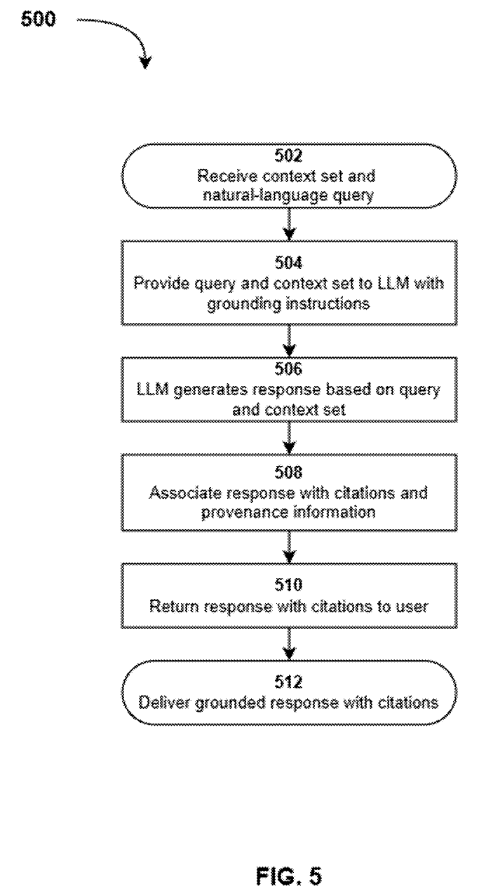

After embeddings are generated and semantically indexed in the vector database 156, an assistant application 158 (e.g., resident at and/or controlled by any of the servers 106B, 108B, 110B), such as a natural language (“NL”) assistant, agent, and/or a chatbot, may provide answers to queries related to the data 152. The assistant application 158 may interact with the LLM 160 to process natural language queries from one or more users 153. Because the underlying chunks preserve contextual cues such as headings and table headers, the generated responses are more likely to remain faithful to the source material. The system 150 may further support predictive services, anomaly-detection services, or proactive discovery services. For example, the assistant application 158 may request a real-time predictive score, a forecast, or a feature-importance explanation from a predictive model. A predictive output may comprise a classification, a regression result, a time-series forecast, an anomaly indication, a feature-importance explanation, a contribution score, a SHAP-like explanation, a what-if scenario analysis, or real-time prediction results. Other examples are possible as well. The grounded response generation process is further described with reference to FIG. 5.

As shown in FIG. 1B, the one or more users 153 may send a question 162 (e.g., a NL query) to the assistant application 158. The assistant application 158 may perform a search 164 against the vector database 156 in order to receive context 166. In some aspects, the search 164 may comprise hybrid contextual retrieval that combines semantic retrieval over chunk embeddings with lexical retrieval over chunk text or an inverted index, as further described with reference to FIG. 4. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users. Other examples are possible as well.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app’s capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

A data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150’s process, so details on user roles and their associated permissions may be included. The system 150 may enforce row-level, column-level, object-level, or application-level permissions. The system 150 may apply space-based or tenant-based access rules. The system 150 may filter outputs according to role or entitlement. The system 150 may log provenance and lineage. The system 150 may sanitize secrets and personally identifiable information. The system 150 may detect or reject prompt-injection attempts. The system 150 may constrain model invocation according to processing-location policies. The system 150 may prevent the assistant application 158 from surfacing source material not authorized for the requesting user. Other examples are possible as well.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create – and maintain – robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user’s 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user’s 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user’s 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153). The contextual metadata may be combined with chunk metadata to support ranking, filtering, or re-ranking of retrieved chunks during hybrid contextual retrieval, as further described with reference to FIG. 4. The contextual metadata gathering leverages the state vectors, bit-stuffed pointers, and logical inference described in paragraphs herein. The associative engine 170 may determine which field values are selected, possible, or excluded by evaluating state vectors, and may construct relevant hypercubes on-demand to provide dimensional context for the question 162.

The system 150 shown in FIG. 1B may be capable of triggering actions and automated processes based on insights derived from user queries. In some cases, the assistant application 158 may analyze the natural language question 162 and the generated answer 168 to identify potential actions. The assistant application 158 may then initiate these actions through appropriate components of the system 150 or external systems. For example, if a natural language question 162 relates to a specific data trend, the system 150 may not only provide an answer 168 describing the trend but may also trigger an automated process to generate a detailed report or alert relevant stakeholders.

The interaction between the users 153, the assistant application 158, and the large language model 160 may be iterative. In some cases, the system 150 may engage in a multi-turn conversation with the users 153, refining and expanding upon the initial natural language question 162 and answer 168. This iterative process may allow for more comprehensive and accurate responses to complex queries.

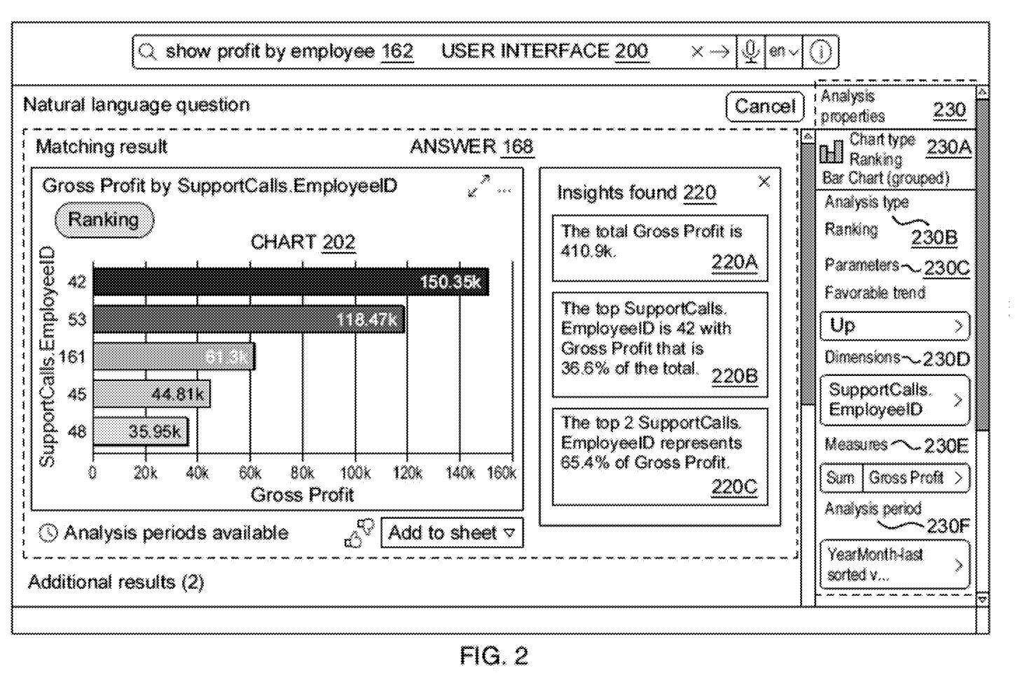

Turning now to FIG. 2, an example user interface 200 is shown. The user interface 200 may provide an interactive environment for users to engage with the natural language processing, insight generation, optimization, causal inference, etc. The user interface 200 may receive natural language analytical objectives from users and display results generated from chunks that preserve contextual integrity, including section headings, table headers, and other structural cues. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. In some aspects, users may enter natural language analytical objectives such as “How should I allocate marketing budget across regions to maximize revenue?” or “What drives sales in the Northeast?” The question 162 may be processed by the assistant application 158 as described in relation to FIG. 1B. The input field may support various types of queries, ranging from simple data requests to complex analytical questions including optimization problems, causal inference questions, etc. Users may ask questions such as “What were the top products last quarter?” or “Show me sales trends by region.” The system may interpret these natural language inputs and convert them into appropriate data operations.

The user interface 200 may also display an answer 168 in response to the user’s question 162. The answer 168 shown in the user interface 200 may correspond to the answer 168 generated by the system 150 as described in FIG. 1B. The answer 168 may comprise natural language text that provides insights, explanations, and interpretations of the data. The answer 168 may be generated using the large language model(s) 160 and may incorporate contextual metadata from the associative engine 170, including exclusion state information that enables the system to identify hidden analytical value in data excluded by the user’s current filters. The natural language response may be tailored to the user’s specific query and may include relevant details, comparisons, and observations about the data. Other examples are possible as well.

A chart 202 may be displayed within the user interface 200. The chart 202 may provide a visual representation of data relevant to the user’s query or the current analytical context. The chart 202 may be generated based on data retrieved from the associative engine 170 and/or from the vector database 156. The chart 202 may be interactive, allowing users to click on specific elements to request additional insights or explanations. The chart 202 may be a visual representation of data relevant to the user’s query or the current context of analysis.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated using the template-based approaches described herein, combined with the natural language generation capabilities of the large language models. The insights may be generated by the system 150 based on the data represented in the chart 202, the user’s query, and other contextual information including exclusion state data from the associative engine 170. Each of these insights may provide different perspectives or analyses of the data. The exclusion state data is derived from the state vectors maintained by the associative engine 170, which track which field values are excluded from the current context, enabling the system to identify hidden analytical value in data not currently selected. Because the underlying chunks preserve contextual cues such as headings and table headers, the insights remain faithful to the source material and provide accurate, grounded observations.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. In some aspects, the analysis properties 230 may include optimization parameters, constraint specifications, causal effect estimates, and exclusion impact metrics. The analysis properties 230 may be derived from the contextual metadata provided by the associative engine 170 and from metadata associated with properly chunked and embedded source materials, including information such as current selection states, exclusion states for field values, hypercube data, statistical measures, comparative values, document identifiers, section identifiers, and policy tags. Other examples are possible as well.

The analysis properties 230 may serve multiple purposes within the system. They may provide the factual foundation for the natural language insights, ensuring that the generated text is grounded in actual data rather than hallucinated information. The analysis properties 230 may also be used to construct prompts for the large language models, providing the necessary context and data points for generating accurate and relevant responses. Additionally, the analysis properties 230 may be used to determine appropriate visualizations and to guide the narrative structure of the insights.

The user interface 200 may support interactive exploration of data. Users may click on elements of the chart 202 to request explanations or additional insights about specific data points. The system may respond to these interactions by generating new insights or by providing more detailed analysis of the selected elements. For example, the chart 202 and the insights 220 may be dynamically updated based on user interactions. For example, if a user selects a particular bar in the chart 202, the system 150 may generate new insights specific to that selection. This interactive capability may be facilitated by the associative engine 170, which can quickly retrieve and analyze relevant data based on user selections.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user’s query, while the associative engine 170 may perform real-time calculations and data retrievals to support the insights and visualizations. The associative engine 170 performs these real-time calculations using hypercubes for multi-dimensional aggregation, state vectors to track the current selection context, and logical inference to determine relevant data before computation. The structure-aware document chunking method, hybrid contextual retrieval method, and grounded response generation method that support the user interface 200 are further described with reference to FIGS. 3-5.

The method 300 describes a structure-aware document chunking process that receives source documents, parses them to produce structured representations identifying hierarchical relationships and structured elements, determines candidate chunk boundaries based on the structured representations, generates chunks while preserving structured elements within individual chunks, and stores the chunks with associated metadata and embedding vectors in a knowledge base such as the vector database 156. The term “structured representation” herein may refer to a data structure that preserves reading order and structural relationships within a source document, and may take the form of a tree, directed acyclic graph, object model, ordered element list, or another representation that identifies hierarchical relationships among document components. As used herein, the term “structured element” may refer to an identifiable document component such as a section, subsection, paragraph, list, table, figure, caption, header, footer, or another element having semantic or layout significance within a source document. Further, as used herein, the term “chunk boundary” or “chunk boundaries” may refer to positions within a source document at which the document content is divided into separate chunks, where such positions may correspond to structural transitions such as section breaks, paragraph breaks, table boundaries, or other structural events.

The method 400 describes a hybrid contextual retrieval process that receives natural language queries from users 153, generates query embeddings, performs semantic retrieval over the chunk embeddings and lexical retrieval over the chunk text stored by the method 300, combines and ranks the candidate chunks, and prepares a context set for answer generation. The method 500 describes a grounded response generation process that receives the context set and query prepared by the method 400, provides them to a language model such as the LLM 160, generates a grounded response based on the retrieved chunks, and returns the response with citations to the user. Together, these methods form a sequential workflow where the method 300 prepares the knowledge base by chunking and embedding source documents, the method 400 retrieves relevant chunks from the knowledge base in response to user queries, and the method 500 generates grounded responses using the retrieved chunks.

FIG. 3 illustrates a flowchart of the method 300 for structure-aware document chunking. The method 300 may be performed by a chunking module. The chunking module may be implemented as a software component executing on one or more devices (or a component(s) thereof) and may comprise executable instructions stored in non-transitory computer-readable memory. The chunking module may reside at the computing device 102, one or more of the plurality of data stores 106, 108, 110, one or more of the databases 106A, 108A, 110A, and/or one or more of the servers 106B, 108B, 110B. Additionally, or in the alternative, the chunking module may reside within the system 150 and may interact with the ML module 102A (e.g., for embedding generation), the vector database 156 (e.g., for chunk storage), and the associative engine 170 (e.g., for metadata association). The associative engine 170 may provide dimensional context, field-level relationships derived from its in-memory data model, or master item definitions that are stored as chunk metadata to support downstream retrieval and ranking. The chunking module may receive source documents via the network 104 from any of the data stores 106, 108, 110, a combination thereof, and/or the like. Other examples are possible as well.

The method 300 may begin at step 302 by receiving a source document. The source document may be received by the computing device 102 via the network 104 from one or more of the data stores 106, 108, 110. The source document may comprise text and at least one structured element. The source document may be a technical manual, a legal document, a policy manual, a slide deck, a spreadsheet, a transcript, a presentation, a portable document format file, an HTML file, a text file, a mail archive, a knowledge article, a support record, a code repository, a media transcript, a combination thereof, and/or the like. Other examples are possible as well. The receiving operation may involve the chunking module invoking an application programming interface to retrieve document content from a source system, reading a file from a file system, receiving a document via a message queue, or accepting a document upload via a user interface.

At step 304, data may be copied or extracted into a processing environment. The processing environment may be hosted on the computing device 102 or on one or more of the servers 106B, 108B, 110B. The data may be copied, linked, or otherwise registered for indexing. Source content may be registered without requiring the entire underlying source content to be persisted in the same environment as the assistant application 158. Source materials may be refreshed manually, on a schedule, based on deltas, in response to events, or according to other synchronization policies. The extraction operation may involve the chunking module allocating memory buffers, deserializing document content from binary or text formats, and/or storing intermediate representations in data structures such as arrays, linked lists, hash maps, or tree structures for subsequent processing. Other examples are possible as well.

At step 306, the source document may be parsed to produce a structured representation. The parsing operation may be performed by the ML module 102A or by a dedicated parser component of another computing device in communication therewith (e.g., one or more of the servers 106B, 108B, 110B). The structured representation may identify chapters, sections, subsections, paragraphs, lists, tables, figures, captions, headers, footers, page boundaries, layout coordinates, etc. The structured representation may take the form of a tree data structure, a directed acyclic graph, an object model instantiated in memory, an ordered element list stored as an array or linked list, or another representation preserving reading order and structural relationships. Other examples are possible as well.

The parser may implement a recursive descent algorithm to traverse document markup, a state machine to process sequential tokens, and/or a machine-learning model trained to classify document regions. For page-based formats such as PDF or image-based documents, the parser may determine bounding boxes by analyzing pixel coordinates, identify columns using clustering algorithms applied to text-block positions, detect cell boundaries using edge-detection techniques, and compute relative positions for text and structured elements using coordinate geometry. The parser may receive native text extracted from document formats, OCR-derived text generated by optical character recognition engines, or serialized content generated from structured data sources such as databases 106A, 108A, 110A. The parser may use one or more commercially available parsing toolkits, proprietary parsers, or neural network-based document understanding models to produce the structured representation, a combination thereof, and/or the like. In some aspects, commercially available document segmentation libraries, chunking toolkits, or boundary-detection modules may also be used for subsequent boundary identification operations. Other examples are possible as well.

At step 308, main body content may be distinguished from repeated headers, footers, page numbers, or decorative elements. The parser may identify and separate content appearing in header regions, footer regions, or margin regions from the main body content of the source document. This distinction may be accomplished by analyzing positional coordinates of text blocks relative to page boundaries, detecting repeated text patterns across multiple pages using string matching or hash-based comparison, classifying regions using a trained machine-learning classifier that evaluates features such as font size, position, and content patterns, or applying rule-based heuristics that identify common header and footer locations, a combination thereof, and/or the like. Other examples are possible as well. The separated header and footer content may be stored in separate data structures for optional inclusion in chunk metadata.

At step 310, candidate boundaries may be identified. The boundary identification may be performed by traversing the structured representation data structure and marking positions corresponding to structural transitions. In some aspects, the boundary identification may be performed using commercially available chunking libraries, document segmentation toolkits, open-source boundary-detection packages, or proprietary boundary-identification modules. Candidate boundaries may correspond to sections, tables, paragraphs, lists, captions, headings, page transitions, or other structural events identified by the parser. The candidate boundaries may be drawn from structural anchors within the structured representation. The identification process may involve iterating through nodes of the tree or graph data structure, evaluating node types against a predefined set of boundary-eligible element types, and recording boundary positions as indices, offsets, or pointers within the document representation. The chunking module may store candidate boundaries in an ordered list or priority queue data structure to facilitate subsequent constraint evaluation and boundary selection.

At step 312, priorities may be assigned to boundary types. As used herein, the term “boundary types” may refer to categories of structural transitions within a document at which chunk boundaries may be placed, including section breaks, subsection breaks, paragraph breaks, sentence boundaries, list boundaries, table boundaries, caption boundaries, and page transitions. As used herein, the term “priority assignments” may refer to numerical or ordinal values associated with boundary types that indicate the relative preference for placing chunk boundaries at each type of structural transition during boundary selection. The priority assignment may be implemented using, as an example, a scoring function that maps boundary types to numerical priority values stored in a configuration table or lookup dictionary. Section breaks may receive higher preference than paragraph breaks. Paragraph breaks may be preferred over sentence boundaries. Other examples are possible as well.

The priority assignments may influence boundary selection when multiple boundary options are available within a given region of the source document. The chunking module may implement the priority scheme by associating each candidate boundary with a priority score, sorting the candidate boundaries by priority score using a sorting algorithm, and selecting higher-priority boundaries first during a constraint satisfaction process. The priority values may be configurable parameters stored in a configuration file, database record, or environment variable accessible to the chunking module. Other examples are possible as well.

At step 314, constraints may be applied. The constraint application may be performed by the chunking module executing a constraint satisfaction algorithm that evaluates provisional chunk boundaries against a set of predefined rules. The constraints may include maximum and minimum chunk size constraints expressed as token counts or character counts, prohibition on splitting within sentences implemented by detecting sentence boundary markers, rules for avoiding table splits implemented by checking element type tags, and rules for preserving headings with introduced content implemented by requiring heading elements to be grouped with subsequent paragraph elements.

Additional constraints may maintain figure-caption pairings by detecting figure and caption element adjacency, preserve ordered lists by grouping list item elements, or account for token budgets of downstream models by computing token counts using a tokenizer compatible with the LLM 160, a combination thereof, and/or the like. The constraint evaluation may involve computing chunk sizes by summing token counts of constituent elements, checking element type sequences against prohibited patterns, and validating structural integrity using graph traversal algorithms. Other examples are possible as well.

At decision 316, the method 300 may determine whether a provisional chunk satisfies the constraints. The determination may be performed by the chunking module evaluating, for example, a Boolean expression that combines the results of individual constraint checks. The chunking module may evaluate whether the provisional chunk is too small by comparing its token count against a minimum threshold, too large by comparing its token count against a maximum threshold, or breaks structure by checking for prohibited element splits. If the provisional chunk satisfies the constraints, the method 300 may proceed to step 320. If the provisional chunk does not satisfy the constraints, the method 300 may proceed to step 318. The constraint satisfaction check may be implemented as a loop that iterates until all provisional chunks satisfy the constraints or a maximum iteration count is reached.

At step 318, boundaries may be merged or split. The merge operation may be performed by the chunking module removing a boundary from the candidate boundary list and combining adjacent segments into a single provisional chunk. As an example, a short section may be merged with an adjacent section by deleting the intervening boundary and updating segment pointers. The split operation may be performed by inserting a new boundary at a lower-priority position within an overly long segment. An overly long subsection may be divided at paragraph boundaries or other lower-priority boundaries by identifying the highest-priority available split point within the segment and inserting a new boundary at that position. After merging or splitting boundaries, the method 300 may return to step 314 for re-evaluation of the constraints. The merge and split operations may be implemented using list manipulation operations that insert, delete, or modify boundary records in the candidate boundary data structure.

At step 320, finalized boundaries may be output. The output operation may involve the chunking module writing the finalized boundary positions to a data structure such as an array of boundary indices, a list of boundary objects containing position and type information, or a serialized representation suitable for storage. The finalized boundaries may then be used to generate chunk text and metadata. The finalized boundaries may be stored in system memory and/or persisted to one of the databases 106A, 108A, 110A so that subsequent reprocessing of the same document version is reproducible or auditable. The storage of finalized boundaries may enable incremental updates where only changed document sections are re-chunked.

At decision 322, the method 300 may determine whether the content includes a table exceeding a maximum chunk size. The determination may be performed by the chunking module iterating through table elements in the structured representation, computing the token count or character count of each table, and comparing the computed size against the maximum chunk size threshold. If the content includes a table exceeding the maximum chunk size, the method 300 may proceed to step 324. If the content does not include a table exceeding the maximum chunk size, the method 300 may proceed to decision 326. The table size computation may involve tokenizing table cell contents using a tokenizer compatible with the embedding model or LLM 160 and summing the token counts across all cells.

At step 324, a table-aware split may be performed. The table-aware split may be implemented by the chunking module executing a specialized algorithm that preserves table interpretability across multiple chunks. The source table may be divided into multiple table chunks by partitioning the row set into subsets based on a target chunk size. Each table chunk may include a row subset together with a copied header so each chunk remains interpretable in isolation. The header copying may be implemented by storing the header row data in a separate data structure and prepending a copy of the header row data to each row subset during chunk generation. Replicated header information may include column headers extracted from the first row or designated header rows, merged heading cells reconstructed from cell span attributes, stub-column labels identifying row categories, units of measure extracted from header cells or caption text, or other tabular context needed to interpret the row values, a combination thereof, and/or the like. Other examples are possible as well.

The chunking module may also carry forward a caption, title, footnote, or page reference associated with the table by storing these elements in chunk metadata. Related techniques may also be applied to wide tables. A table may be partitioned by column groups while repeating key identifier columns in each resulting chunk. The column partitioning may be implemented by identifying key columns based on column position, header content, or configuration parameters, and including copies of the key columns in each column-group chunk. The system may select row-based splitting, column-based splitting, or a combination thereof based on table geometry computed from row and column counts, token counts computed for rows versus columns, or downstream retrieval requirements specified in configuration parameters. Other examples are possible as well.

At decision 326, the document type may be determined. The document type determination may be performed by the chunking module executing a classification algorithm that evaluates document features. The document type may be determined based on metadata tags extracted from document properties, sentence length statistics computed by averaging token counts across sentences, content density computed as the ratio of text content to whitespace or formatting elements, formatting cues such as heading frequency or list prevalence, or element distributions computed as histograms of element types, a combination thereof, and/or the like. Other examples are possible as well.

The document-type assessment may consider metadata or source tags read from document properties or file system attributes, average sentence length computed using a sentence tokenizer, content density computed by dividing text character count by total document size, formatting cues detected by counting heading elements or analyzing font variations, element distributions computed by counting occurrences of each element type, OCR quality estimated by analyzing character confidence scores or error patterns, or other features extracted from the structured representation. If the document is a reference document as determined by the classification algorithm, the method 300 may proceed to step 328. If the document is a narrative document, the method 300 may proceed to step 330.

At step 328, a reference policy may be applied, which may be a type of chunking policy. As used herein, the term “chunking policy” may refer to a configuration object, parameter set, or rule set that specifies chunking behavior for a particular document type or content category, including chunk-size thresholds, boundary priorities, structure-preservation rules, and alignment preferences. The reference policy may be implemented as a configuration object or parameter set that specifies chunking behavior for reference-type documents. The reference policy may employ a smaller maximum size by setting the maximum token count threshold to a lower value such as approximately one thousand tokens. The reference policy may align chunks to API endpoints or other technical units by detecting endpoint definitions using pattern matching and placing boundaries at endpoint boundaries. The reference policy may preserve parameter lists by grouping parameter definition elements together. The reference policy may produce smaller chunks of approximately one thousand tokens by enforcing a stricter maximum size constraint during the constraint satisfaction process. The policy parameters may be stored in a configuration file, database record, or policy registry accessible to the chunking module.

At step 330, a narrative policy may be applied. The narrative policy may be implemented as a configuration object or parameter set that specifies chunking behavior for narrative-type documents. The narrative policy may employ a larger maximum size by setting the maximum token count threshold to a higher value such as approximately two thousand tokens. The narrative policy may preserve longer sections by increasing the minimum size threshold and reducing the priority of paragraph-level splits. The narrative policy may split at section or paragraph breaks by assigning higher priority scores to section and paragraph boundaries relative to sentence boundaries. The narrative policy may produce larger chunks of approximately two thousand tokens by enforcing a more permissive maximum size constraint during the constraint satisfaction process. The policy parameters may be stored in a configuration file, database record, or policy registry accessible to the chunking module. Other examples are possible as well.

At step 332, chunks may be generated based on the finalized boundaries and the selected policy. The chunk generation may be performed by the chunking module iterating through the finalized boundary positions and extracting text content between consecutive boundaries. The chunks may be aligned with the finalized chunk boundaries determined through the constraint application and boundary selection processes. The extraction may involve reading character sequences from the source document representation, concatenating text content from constituent elements, and storing the resulting chunk text in a chunk record data structure. Each chunk record may include the extracted text, positional information indicating the chunk’s location within the source document, and references to the source document and constituent elements.

At step 334, chunks may optionally be supplemented with various enrichment data using a language model. As used herein, the term “enrichment data” may refer to supplemental information generated for a chunk using a language model or other processing technique, including summaries, titles, synonyms, related terms, domain-specific labels, keywords, or other derived content that enhances the chunk’s retrievability or interpretability. The enrichment may be performed by the ML module 102A (or a device(s) in communication therewith) and/or by invoking the LLM 160 via an application programming interface. As an example, the LLM 160 may generate summaries by processing chunk text through a summarization prompt and extracting a condensed representation, titles by processing chunk text through a title generation prompt, synonyms by identifying key terms and generating alternative phrasings, related terms by analyzing semantic relationships, or domain-specific labels by classifying chunk content against a domain taxonomy, a combination thereof, and/or the like. Other examples are possible as well.

Such enrichment may be appended to the text used for embedding by concatenating the enrichment content with the original chunk text, stored as separate metadata fields in the chunk record, placed into a lexical index maintained alongside the vector database 156, or used in subsequent re-ranking operations during retrieval. The enrichment process may involve constructing prompts that include the chunk text and instructions for the language model, transmitting the prompts to the LLM 160, receiving generated responses, and parsing the responses to extract enrichment content.

At step 336, metadata may be generated for each chunk. The metadata generation may be performed by the chunking module extracting information from the structured representation and the source document properties. The metadata may include a document identifier generated as a unique identifier such as a UUID or hash of document content, a section identifier indicating the chunk’s position within the document hierarchy, a page range indicating the source pages from which the chunk was extracted, an element type indicating whether the chunk contains paragraphs, tables, lists, or other element types, a policy identifier indicating which chunking policy was applied, a version identifier indicating the document version or chunk generation timestamp, a timestamp indicating when the chunk was created, an access-control label indicating user or role permissions for the chunk, and domain tags indicating subject matter categories, a combination thereof, and/or the like. Other examples are possible as well. The metadata may support retrieval by enabling filtered searches, filtering by enabling exclusion of unauthorized content, explainability by providing provenance information for generated answers, or auditing by enabling traceability of answer sources. The metadata may include any suitable attributes, such as summary text generated during enrichment, keywords extracted using term frequency analysis, or user-interface citation information formatted for display in the assistant application 158.

At step 338, each chunk may be converted into an embedding vector. The embedding generation may be performed (or caused to be performed) by the ML module 102A and/or by invoking an embedding model accessible via the network 104. The embedding vector may be generated using the LLM 160, an embedding model such as a sentence transformer or text embedding model, and/or other machine-learning models trained to produce dense vector representations of text. The embedding generation process may involve tokenizing the chunk text using a tokenizer compatible with the embedding model, passing the token sequence through the neural network layers of the embedding model, and extracting the output vector from a designated layer such as the final hidden state or a pooled representation. The embedding vector may be generated from the chunk text alone or from enriched text that includes a summary, title, keywords, or synonyms concatenated with the original chunk text.

Different embedding models may be used for different source types based on configuration parameters or automatic model selection. Transformer-based models implementing attention mechanisms, recurrent models implementing sequential processing, convolutional models implementing local feature extraction, or more specialized embedding models optimized for specific domains may be employed, a combination thereof, and/or the like. Other examples are possible as well. The resulting embedding vector may be a dense numerical array of fixed dimensionality such as 768, 1024, or 1536 dimensions depending on the embedding model architecture.

At step 340, chunk records, embeddings, and metadata may be stored in a vector database. The storage operation may be performed by transmitting the chunk data to the vector database 156 via the network 104. The vector database may correspond to the vector database 156 of FIG. 1B and may be hosted on one of the data stores 106, 108, 110. The vector database may organize the embeddings in a manner that reflects the semantic meaning of the content within each chunk by constructing an index structure such as an approximate nearest neighbor index, a hierarchical navigable small world graph, or an inverted file index that enables efficient similarity search. The vector database may further maintain identifiers linking the embeddings to corresponding chunk text and metadata by storing foreign key relationships or document references.

In some implementations, chunk text is stored in the same database as the embeddings in a unified document store. In other implementations, embeddings are stored in a vector store optimized for similarity search while text and metadata are stored in a document database or search index linked by chunk identifiers, enabling hybrid retrieval architectures. The storage operation may involve serializing chunk records to a storage format, transmitting the serialized data via database client protocols, and confirming successful persistence through acknowledgment responses. Other examples are possible as well.

The method 300 may conclude at step 342, with chunks stored in the knowledge base. Upon completion, the chunks, embeddings, and metadata are available for retrieval by the assistant application 158 in response to user queries. The stored chunks may be retrieved using semantic search over the embedding vectors, lexical search over the chunk text, or hybrid retrieval combining both approaches as further described with reference to FIG. 4. The grounded response generation process that uses the retrieved chunks is further described with reference to FIG. 5.

As used herein, the term “retrieval engine” or “retrieval module” may refer to a software component configured to receive natural-language queries, generate query embeddings, perform semantic and lexical searches over stored chunks, rank candidate chunks based on relevance signals and metadata, and prepare context sets for answer generation by a language model. The retrieval engine may be implemented by the assistant application 158 in conjunction with the vector database 156. FIG. 4 illustrates a flowchart of the method 400 for hybrid contextual retrieval. The method 400 may be performed by a retrieval engine or retrieval module. The retrieval engine may be implemented as a software component executing on one or more processors and may comprise executable instructions stored in non-transitory computer-readable memory. The retrieval engine may reside at the computing device 102 and/or one or more of the servers 106B, 108B, 110B, within the system 150, or may be in communication with the computing device 102 via the network 104. The retrieval engine may be implemented by the assistant application 158 in conjunction with the vector database 156. The retrieval engine may interact with the ML module 102A for embedding generation, the vector database 156 for chunk retrieval, and the associative engine 170 for contextual metadata. The associative engine 170 supplies the retrieval engine with current selection states derived from state vectors, relevant hypercube subsets, and relationship information determined through logical inference, which the retrieval engine may then use to filter, boost, or re-rank candidate chunks. The chunks retrieved by the method 400 may be generated by the chunking module as described with reference to FIG. 3.

The method 400 may begin at step 402 by receiving a natural-language query from a user. The natural-language query may correspond to a question 162 received from users 153 as shown in FIG. 1B. The natural-language query may be received by the assistant application 158 via a user interface such as the user interface 200 of FIG. 2. The receiving operation may involve the retrieval engine accepting text input from a client application, receiving a message via an application programming interface, or processing a voice-to-text transcription. The natural-language query may be a question, a request for information, a search phrase, a conversational utterance, a combination thereof, and/or the like. Other examples are possible as well.

At step 404, a query embedding may be generated. The query embedding may be generated using the same embedding model used for chunks stored in the knowledge base or a compatible embedding model. The embedding generation may be performed by the ML module 102A and/or one or more of the servers 106B, 108B, 110B of FIG. 1A and/or by invoking the large language model 160 of FIG. 1B via an application programming interface. The query embedding generation process may involve tokenizing the natural-language query using a tokenizer compatible with the embedding model, passing the token sequence through neural network layers of the embedding model, and extracting an output vector from a designated layer. The neural network layers may include transformer encoder layers that apply self-attention mechanisms to compute contextual representations of input tokens, feed-forward layers that apply non-linear transformations to the attention outputs, and layer normalization operations that stabilize training and inference. The output vector may be extracted from the final hidden state corresponding to a classification token, from a pooled representation computed by averaging or max-pooling hidden states across all tokens, or from a dedicated embedding head that projects the hidden states to a target dimensionality, a combination thereof, and/or the like. Other examples are possible as well. The query embedding may be normalized to unit length using L2 normalization to facilitate cosine similarity computation during retrieval. The query embedding may be a dense numerical array of fixed dimensionality matching the dimensionality of the chunk embeddings stored in the vector database 156.

The method 400 may then proceed along two parallel paths. At step 406A, a semantic search may be performed over a vector database. The vector database may correspond to the vector database 156 of FIG. 1B. The semantic search may identify chunks whose embedding vectors are similar to the query embedding. The similarity may be computed using cosine similarity, dot product similarity, Euclidean distance, a combination thereof, and/or the like. Other examples are possible as well.

At step 406B, a lexical search may be performed in parallel with the semantic search. The lexical search may be performed over an inverted index or other searchable text representation of the chunks. The inverted index may be a data structure that maps terms to posting lists, where each posting list contains identifiers of chunks that contain the corresponding term along with term frequency counts and positional information. The lexical search may be based on Term Frequency-Inverse Document Frequency (TF-IDF), Best Matching 25 (BM25), term matching, regular expressions, ontology lookups, synonym dictionaries, a combination thereof, and/or the like. Other examples are possible as well.

In some aspects, the method 400 may expand the natural-language query before performing the semantic search, the lexical search, or both. The query expansion may be performed by the ML module 102A or by invoking the LLM 160 via an application programming interface. A language model or a query-rewrite component may generate alternative phrasings, abbreviations, entity aliases, synonyms, or domain-specific terminology for query expansion. The query expansion process may involve providing the original query to the language model with instructions to generate semantically equivalent reformulations, extracting key terms from the query and looking up synonyms in a thesaurus or ontology data structure, identifying named entities in the query and retrieving known aliases from an entity database, or applying learned query expansion models trained on query-document relevance pairs, a combination thereof, and/or the like. Other examples are possible as well. The query expansion may improve recall by matching chunks containing related terms not present in the original query. In other aspects, enriched chunk metadata containing summaries or synonyms may improve recall without requiring query rewriting.

At step 408, the semantic and lexical candidate sets may be combined and de-duplicated. The combination operation may involve merging the candidate chunk lists from step 406A and step 406B into a unified candidate set. The de-duplication operation may involve identifying chunks appearing in both candidate sets and retaining a single instance of each duplicate chunk. The de-duplication may be performed by comparing chunk identifiers, computing hash values of chunk content, a combination thereof, and/or the like. Other examples are possible as well. The combined candidate set may include chunks identified by semantic similarity, lexical relevance, or both.

At step 410, candidates may be ranked. The ranking may be performed by the retrieval engine (e.g., the assistant application 158) executing a scoring algorithm that combines multiple relevance signals into a unified ranking score. The ranking may account for semantic similarity scores derived from the semantic search, lexical scores derived from the lexical search, structural correspondence between the query and chunk content, policy tags associated with chunks, document types indicating source document categories, freshness indicators indicating recency of source content, source authority scores indicating reliability of source documents, user entitlements indicating access permissions, a combination thereof, and/or the like. Other examples are possible as well.

At decision 412, the method 400 may determine whether any chunks have conflicting access-control labels for the current user. The determination may be performed by the retrieval engine evaluating access-control labels stored in chunk metadata against user entitlements, role assignments, or permission records associated with the requesting user. The access control evaluation may involve retrieving the current user’s identity and role assignments from an authentication context or session object, loading the user’s entitlements from a permissions database or access control list stored in one of the databases 106A, 108A, 110A, iterating through the candidate chunks and comparing each chunk’s access-control label against the user’s entitlements using set membership tests or role hierarchy traversal, and flagging chunks for which the user lacks the required permission level.

The entitlement data structures may include role-based access control tables mapping roles to permitted resources, attribute-based access control policies specifying conditions under which access is granted, or access control lists associating resource identifiers with permitted user or group identifiers, a combination thereof, and/or the like. Other examples are possible as well. Document-level or chunk-level access-control labels may restrict retrieval to content a given user is authorized to see. If any chunks have conflicting access-control labels, the method 400 may proceed to step 414. If no chunks have conflicting access-control labels, the method 400 may proceed to step 416.

At step 414, restricted chunks may be excluded from the candidate set. The exclusion operation may involve removing chunks from the ranked candidate list for which the current user lacks authorization. The exclusion may be performed before ranking, after ranking, or at both stages. The exclusion operation may ensure that unauthorized content is not included in the context provided to the language model for answer generation.

At step 416, top-ranked chunks may be selected subject to a token budget. The token budget may specify a maximum number of tokens that may be included in the context provided to the language model. The token budget enforcement may be performed by the retrieval engine executing, as an example, a greedy selection algorithm that iterates through the ranked candidate list in order of decreasing relevance score. The selection operation may involve initializing a token counter to zero, iterating through the ranked candidate list and for each chunk computing the token count using a tokenizer compatible with the language model, adding the chunk to the selected set and incrementing the token counter if the cumulative token count would not exceed the budget, and terminating the iteration when the token budget is reached or exceeded or when all candidates have been evaluated. The token count for each chunk may be computed by invoking the tokenizer’s encode function on the chunk text and counting the resulting token identifiers. The selection may prioritize higher-ranked chunks while respecting the token budget constraint. In some aspects, the selection algorithm may implement bin-packing heuristics to maximize the total relevance of selected chunks within the token budget, or may reserve token capacity for system prompts, instructions, or formatting overhead, a combination thereof, and/or the like. Other examples are possible as well.

At step 418, selected chunks may be packed into a prompt. The prompt construction may be performed by the assistant application 158 or by a prompt builder component executing on the computing device 102 or one of the servers 106B, 108B, 110B. The context packing may preserve section headings associated with the selected chunks by prepending heading text extracted from chunk metadata to the chunk content, replicated table headers generated during structure-aware chunking by including the header rows stored with each table chunk, citations linking chunks to source documents by appending source identifiers or document references to each chunk, and neighboring context providing additional surrounding information by including adjacent chunks or parent section summaries. The prompt construction operation may involve concatenating a system message specifying the assistant’s role and behavior constraints, the packed chunk content formatted with delimiters or markup indicating chunk boundaries, the natural-language query, and instructions for the language model. The instructions may require the language model to answer only from the retrieved content by including explicit constraints such as “Answer based only on the provided context,” to identify uncertainty when information is insufficient by including instructions such as “If the context does not contain sufficient information, state that you cannot answer,” or to cite supporting chunks in the generated response by including instructions such as “Cite the source for each claim using the provided references,” a combination thereof, and/or the like. Other examples are possible as well. The context packing operation may format the chunk content in a manner suitable for consumption by the language model while maintaining structural cues that support accurate answer generation.

The method 400 may conclude at step 420, with the context set prepared for answer generation. Upon completion, the context set comprising the selected and packed chunks may be provided to a language model such as the LLM 160 for grounded response generation. The grounded response generation process is further described with reference to FIG. 5.

FIG. 5 illustrates a flowchart of a method 500 for grounded response generation. The method 500 may be performed by a response generation module. The response generation module may be implemented as a software component executing on one or more processors and may comprise executable instructions stored in non-transitory computer-readable memory. The response generation module may reside at the computing device 102, one or more of the plurality of data stores 106, 108, 110, one or more of the databases 106A, 108A, 110A, and/or one or more of the servers 106B, 108B, 110B. Additionally, or in the alternative, the response generation module may reside within the system 150 and may interact with the ML module 102A, the vector database 156, and/or the associative engine 170 . The associative engine 170 may provide deterministic calculation results, current selection context derived from state vectors, and exclusion state information that the response generation module incorporates into the prompt or uses to validate the grounded response against the current analytical state. For example, the method 500 may be performed by the assistant application 158 in conjunction with the large language model 160 together serving as the response generation module. The chunks from which the context set is derived may be generated by the chunking module described herein.

The method 500 may begin at step 502 by receiving a context set and a natural-language query. The context set may be prepared by a preceding retrieval process. The preceding retrieval process may correspond to the method 400 of FIG. 4. The preceding retrieval process may select and pack relevant chunks from a knowledge base. The knowledge base may correspond to the vector database 156 of FIG. 1B. The context set may comprise one or more chunks selected based on semantic similarity scores, lexical relevance scores, structural correspondence, policy tags, document types, freshness indicators, source authority, user entitlements, a combination thereof, and/or the like. Other examples are possible as well. The natural-language query may correspond to a question 162 received from users 153 as shown in FIG. 1B. The receiving operation may involve the response generation module accepting the context set and natural-language query from the retrieval engine via an internal function call, a message queue, an application programming interface, a combination thereof, and/or the like. Other examples are possible as well.

At step 504, the query and context set may be provided to a large language model. The large language model may correspond to the large language model 160. The large language model may be accessible via the ML module 102A of FIG. 1A or via an application programming interface over the network 104. Step 504 may involve constructing a prompt. The prompt may include a system message specifying the assistant’s role and behavior constraints, the packed chunk content formatted with delimiters or markup indicating chunk boundaries, the natural-language query, and instructions for the large language model.

The instructions may require the large language model to answer only from retrieved content. The instructions may require the large language model to identify uncertainty when information is insufficient. The instructions may require the large language model to cite supporting chunks in the generated response. The instructions may include explicit constraints such as “Answer based only on the provided context.” The instructions may include directives such as “If the context does not contain sufficient information, state that you cannot answer.” The instructions may include citation requirements such as “Cite the source for each claim using the provided references.” The prompt construction operation may format the chunk content in a manner suitable for consumption by the large language model while maintaining structural cues. The structural cues may include section headings, replicated table headers, citations, and neighboring context. Other examples are possible as well.

At step 506, a response may be generated based on the query and the context set. The response generation may be performed by the large language model 160 processing the prompt and producing output text. The large language model may apply attention mechanisms to identify relevant portions of the context set corresponding to the natural-language query. The large language model may generate natural language text. The natural language text may answer the query based on information contained in the context set. The response may include explanations, summaries, comparisons, observations, a combination thereof, and/or the like. Other examples are possible as well. Because the underlying chunks preserve contextual cues such as headings and table headers, the generated response is more likely to remain faithful to the source material. The associative engine 170 further supports response faithfulness by providing deterministic, traceable calculations that can be cross-referenced against the LLM’s generated response, ensuring that numerical claims in the response are grounded in governed computations rather than model inference alone. The response generation operation may involve the large language model iteratively predicting tokens based on the prompt and previously generated tokens until a termination condition is satisfied, for example.

At step 508, the response may be associated with citations, links, source identifiers, or other provenance information derived from chunk metadata. The association operation may be performed by the response generation module and/or by the assistant application 158. The citations may identify source documents or source locations of chunks included in the context set. The provenance information may include document identifiers, section identifiers, page ranges, element types, policy identifiers, version identifiers, timestamps, a combination thereof, and/or the like. Other examples are possible as well.

The association operation at step 508 may involve parsing the generated response to identify claims or statements, matching the claims or statements to corresponding chunks in the context set, and appending citation markers or hyperlinks to the response text. The citation markers may reference chunk metadata stored in the vector database 156. The provenance information may support auditing and traceability. The provenance information may enable users to verify the accuracy of the generated response by examining the source material. Other examples are possible as well.

At step 510, the response may be returned together with citations to the user. The response may correspond to the answer 168 provided to the users 153 as shown in FIG. 1B. The returning operation may involve transmitting the response and associated citations to a client application via the network 104. The response may be displayed in a user interface. The user interface may correspond to the user interface 200 of FIG. 2. The citations may be rendered as clickable links, footnotes, inline references, expandable panels, a combination thereof, and/or the like. The user may select a citation to view the corresponding source chunk or navigate to the source document. The method 500 may conclude at step 512 with delivery of a grounded response with citations. Upon completion, the user receives a response. The response is grounded in the retrieved chunks from the knowledge base, and the response may include the provenance information enabling verification against source materials.

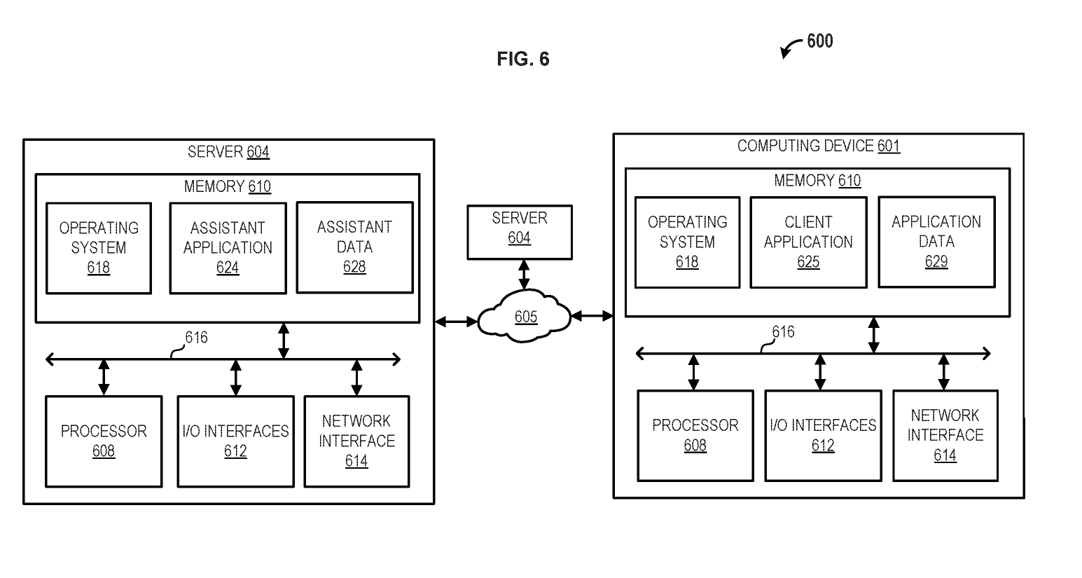

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the devices of the system 100 shown in FIG. 1A. In an aspect, some or all steps of any described method may be performed on a computing device as described herein. The computing device 601 may comprise one or multiple computers configured to store application data 629, and/or the like. The server 602 may comprise one or multiple computers configured to store assistant data 629. Multiple servers 602 may communicate with the computing device 601 via the through the network 604. The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may execute software stored within the system memory 610, to communicate data to and from the system memory 610, and to generally control operations of the computing device 601 and the server 602 pursuant to the software. The I/O interfaces 612 may be used to receive user input from, and/or for providing system output to, one or more devices or components. User input may be provided via, for example, a keyboard and/or a mouse. System output may be provided via a display device and a printer (not shown).

I/O interfaces 612 may include, for example, a serial port, a parallel port, a Small Computer System Interface (SCSI), an infrared (IR) interface, a radio frequency (RF) interface, and/or a universal serial bus (USB) interface. The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604. The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media.

Note that the system memory 610 may have a distributed architecture, where various components are situated remote from one another, but may be accessed by the processor 608. The software in system memory 610 may include one or more software programs, each of which comprises an ordered listing of executable instructions for implementing logical functions. In the example of FIG. 6, the software in the system memory 610 of the computing device 601 may comprise the application data 629, the client application 625, and a suitable operating system (O/S) 618. In the example of FIG. 6, the software in the system memory 610 of the server 602 may comprise the assistant data 629, the assistant application 624, and a suitable operating system (O/S) 618. The operating system 618 essentially controls the execution of other computer programs and provides scheduling, input-output control, file and data management, memory management, and communication control and related services. For purposes of illustration, application programs and other executable program components such as the operating system 618 are shown herein as discrete blocks, although it is recognized that such programs and components may reside at various times in different storage components of the computing device 601 and/or the server 602.

An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

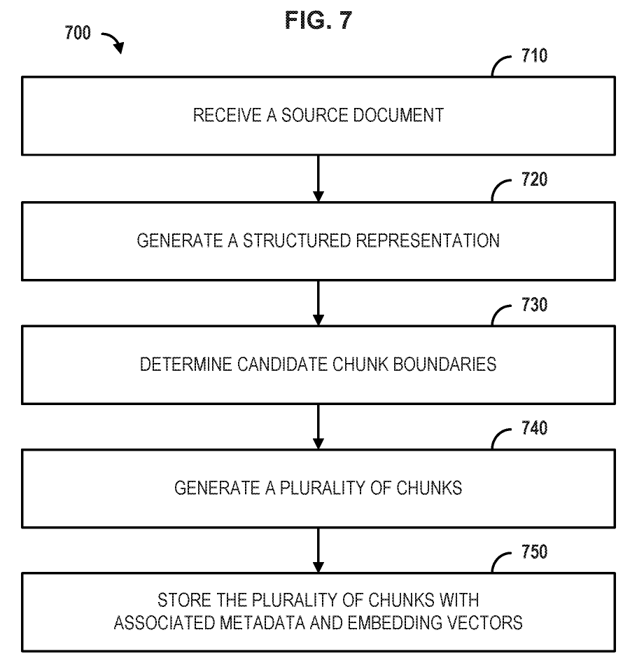

FIG. 7 illustrates a flowchart of a method 700 for structure-aware document chunking. The method 700 may be performed by a chunking module of a computing device. The chunking module may reside at the computing device 102 of FIG. 1A. The chunking module may be in communication with the computing device 102 via the network 104. The chunking module may interact with the ML module 102A for embedding generation. The chunking module may reside within the system 150 of FIG. 1B. The chunking module may reside at one or more of the servers 106B, 108B, 110B of FIG. 1A. The chunking module may be implemented as a software component executing on one or more processors. The chunking module may comprise executable instructions stored in non-transitory computer-readable memory. Other examples are possible as well. For ease of explanation, the method 700 will be described as being performed by the computing device 102.

The method 700 may begin at step 710 by receiving a source document. The source document may be received by the computing device 102 via the network 104 from one or more of the data stores 106, 108, 110. The source document may comprise text and at least one structured element. The source document may be a technical manual, a legal document, a policy manual, a slide deck, a spreadsheet, a transcript, a presentation, a portable document format file, an HTML file, a text file, a mail archive, a knowledge article, a support record, a code repository, a media transcript, a combination thereof, and/or the like.

At step 720, a structured representation may be generated based on the source document. The structured representation may identify a hierarchy of sections within the source document. The structured representation may identify at least one structured element within the source document. The structured representation may take the form of a tree data structure, a directed acyclic graph, an object model instantiated in memory, an ordered element list stored as an array or linked list, or another representation preserving reading order and structural relationships. The structured representation may identify chapters, sections, subsections, paragraphs, lists, tables, figures, captions, headers, footers, page boundaries, and layout coordinates.

At step 730, candidate chunk boundaries may be determined based on the structured representation. The candidate chunk boundaries may be determined based on the hierarchy of sections in the structured representation. The boundary determination may be performed by traversing the structured representation data structure and marking positions corresponding to structural transitions. Candidate boundaries may correspond to sections, tables, paragraphs, lists, captions, headings, page transitions, or other structural events identified during parsing. The chunking module may assign different priorities to different boundary types. Section breaks may receive higher preference than paragraph breaks. Paragraph breaks may be preferred over sentence boundaries. The chunking module may apply one or more structure-preservation constraints to the candidate chunk boundaries. As used herein, the term “structure-preservation constraints” may refer to rules or conditions applied during chunk boundary selection that maintain the integrity of structured elements within chunks, including size constraints specifying maximum and minimum chunk sizes, and constraints that avoid splitting structured elements such as tables, lists, or heading-content groupings across chunk boundaries. The structure-preservation constraints may comprise at least a size constraint and a constraint avoiding splitting the at least one structured element.

At step 740, a plurality of chunks may be generated based on the determined boundaries. The at least one structured element may be preserved within a single chunk of the plurality of chunks. The chunk generation may be performed by the chunking module iterating through the finalized boundary positions and extracting text content between consecutive boundaries. Each chunk record may include the extracted text, positional information indicating the chunk’s location within the source document, and references to the source document and constituent elements.

In some aspects, the chunking module may determine, based on one or more document characteristics of the source document, a chunking policy from among a plurality of chunking policies. The plurality of chunks may be generated based on the chunking policy. The document characteristics may include metadata tags, sentence length statistics, content density, formatting cues, element distributions, a combination thereof, and/or the like. The chunking policy may specify chunk-size thresholds, boundary priorities, or structure-preservation rules. A reference-document policy may generate relatively smaller chunks for technical reference material. A narrative-document policy may generate relatively larger chunks for narrative material. Other examples are possible as well.

In some aspects, the chunking module may generate, based on at least one chunk of the plurality of chunks, enrichment data comprising at least one of a summary, a title, one or more synonyms, or one or more domain-specific labels. The enrichment data may be caused to be associated with the at least one chunk. The enrichment may be performed by the ML module 102A and/or by invoking the LLM 160 via an application programming interface. The enrichment data may be appended to the text used for embedding, stored as separate metadata fields in the chunk record, placed into a lexical index maintained alongside the vector database 156, and/or used in subsequent re-ranking operations during retrieval.

In some aspects, the chunking module may determine, based on the structured representation, one or more structure-preservation constraints. The plurality of candidate chunk boundaries may be generated based on the one or more structure-preservation constraints. The one or more structure-preservation constraints may comprise at least a size constraint and a constraint that avoids splitting the at least one structured element. The size constraint may specify maximum and minimum chunk sizes expressed as token counts or character counts. The constraint that avoids splitting the at least one structured element may be implemented by checking element type tags and requiring structured elements to be grouped within single chunks.

In some aspects, the chunking module may determine a plurality of boundary types corresponding to the plurality of candidate chunk boundaries. The chunking module may generate, based on the plurality of boundary types, priority assignments for the plurality of candidate chunk boundaries. Section breaks may receive higher priority than paragraph breaks. Paragraph breaks may receive higher priority than sentence boundaries. The priority assignments may be implemented using a scoring function that maps boundary types to numerical priority values stored in a configuration table or lookup dictionary. Other examples are possible as well.

At step 750, the plurality of chunks may be stored with associated metadata and embedding vectors in a knowledge base. The knowledge base may correspond to the vector database 156 of FIG. 1B. The storage operation may be performed by transmitting the chunk data to the vector database 156 via the network 104. The associated metadata may comprise a document identifier, a section identifier, a page range, an element type, a policy identifier, a version identifier, a timestamp, an access-control label, domain tags, a combination thereof, and/or the like. Other examples are possible as well.

The embedding vectors may be generated using an LLM such as the LLM 160, an embedding model such as a sentence transformer or text embedding model, or other machine-learning model trained to produce dense vector representations of text. The vector database 156 may organize the embeddings in a manner reflecting the semantic meaning of the content within each chunk by constructing an index structure enabling efficient similarity search. Upon completion of the method 700, the chunks, embeddings, and metadata may be available for retrieval by the assistant application 158 in response to user queries.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a computing device, a source document;
generating, based on the source document, a structured representation that identifies a hierarchy of sections and at least one structured element within the source document;
determining, based on the hierarchy of sections in the structured representation, a plurality of candidate chunk boundaries;
generating, based on the plurality of candidate chunk boundaries, a plurality of chunks, wherein the at least one structured element is preserved within a single chunk of the plurality of chunks; and
causing the plurality of chunks, associated metadata, and embedding vectors to be stored in one or more knowledge bases, wherein the associated metadata and embedding vectors facilitate natural language query processing associated with the source document.

2. The method of claim 1, further comprising:
determining that a table within the source document exceeds a maximum chunk size; and
generating, based on the determining that the table exceeds the maximum chunk size, a plurality of table chunks, each table chunk of the plurality of table chunks including a subset of rows from the table and a replicated copy of one or more header rows from the table.

3. The method of claim 1, further comprising:
determining, based on one or more document characteristics of the source document, a chunking policy from among a plurality of chunking policies; and
generating the plurality of chunks based on the chunking policy.

4. The method of claim 1, further comprising:
generating, based on at least one chunk of the plurality of chunks, enrichment data comprising at least one of a summary, a title, one or more synonyms, or one or more domain-specific labels; and
causing the enrichment data to be associated with the at least one chunk.

5. The method of claim 1, wherein the associated metadata comprises at least one of a document identifier, a section identifier, a page range, an element type, a policy identifier, a version identifier, or an access-control label.

6. The method of claim 1, further comprising:
determining, based on the structured representation, one or more structure-preservation constraints; and
generating the plurality of candidate chunk boundaries based on the one or more structure-preservation constraints, the one or more structure-preservation constraints comprising at least a size constraint and a constraint that avoids splitting the at least one structured element.

7. The method of claim 1, further comprising:
determining a plurality of boundary types corresponding to the plurality of candidate chunk boundaries; and
generating, based on the plurality of boundary types, priority assignments for the plurality of candidate chunk boundaries, wherein section breaks receive higher priority than paragraph breaks and paragraph breaks receive higher priority than sentence boundaries.

8. An apparatus comprising:
one or more processors; and
a memory storing instructions that, when executed by the one or more processors, cause the one or more processors to:
receive a source document;
generate, based on the source document, a structured representation that identifies a hierarchy of sections and at least one structured element within the source document;
determine, based on the hierarchy of sections in the structured representation, a plurality of candidate chunk boundaries;
generate, based on the plurality of candidate chunk boundaries, a plurality of chunks, wherein the at least one structured element is preserved within a single chunk of the plurality of chunks; and
cause the plurality of chunks, associated metadata, and embedding vectors to be stored in one or more knowledge bases, wherein the associated metadata and embedding vectors facilitate natural language query processing associated with the source document.

9. The apparatus of claim 8, wherein the instructions, when executed by the one or more processors, further cause the one or more processors to:
determine that a table within the source document exceeds a maximum chunk size; and
generate, based on the determination that the table exceeds the maximum chunk size, a plurality of table chunks, each table chunk of the plurality of table chunks including a subset of rows from the table and a replicated copy of one or more header rows from the table.

10. The apparatus of claim 8, wherein the instructions, when executed by the one or more processors, further cause the one or more processors to:
determine, based on one or more document characteristics of the source document, a chunking policy from among a plurality of chunking policies; and
generate the plurality of chunks based on the chunking policy.

11. The apparatus of claim 8, wherein the instructions, when executed by the one or more processors, further cause the one or more processors to:
generate, based on at least one chunk of the plurality of chunks, enrichment data comprising at least one of a summary, a title, one or more synonyms, or one or more domain-specific labels; and
cause the enrichment data to be associated with the at least one chunk.

12. The apparatus of claim 8, wherein the associated metadata comprises at least one of a document identifier, a section identifier, a page range, an element type, a policy identifier, a version identifier, or an access-control label.

13. The apparatus of claim 8, wherein the instructions, when executed by the one or more processors, further cause the one or more processors to:
determine, based on the structured representation, one or more structure-preservation constraints; and
generate the plurality of candidate chunk boundaries based on the one or more structure-preservation constraints, the one or more structure-preservation constraints comprising at least a size constraint and a constraint that avoids splitting the at least one structured element.

14. The apparatus of claim 8, wherein the instructions, when executed by the one or more processors, further cause the one or more processors to:
determine a plurality of boundary types corresponding to the plurality of candidate chunk boundaries; and
generate, based on the plurality of boundary types, priority assignments for the plurality of candidate chunk boundaries, wherein section breaks receive higher priority than paragraph breaks and paragraph breaks receive higher priority than sentence boundaries.

15. A system comprising:
a first computing device configured to:
receive a source document;
generate, based on the source document, a structured representation that identifies a hierarchy of sections and at least one structured element within the source document;
determine, based on the hierarchy of sections in the structured representation, a plurality of candidate chunk boundaries; and
generate, based on the plurality of candidate chunk boundaries, a plurality of chunks, wherein the at least one structured element is preserved within a single chunk of the plurality of chunks;
and
a second computing device comprising one or more knowledge bases and configured to store the plurality of chunks, associated metadata, and embedding vectors in the one or more knowledge bases, wherein the associated metadata and embedding vectors facilitate natural language query processing associated with the source document.

16. The system of claim 15, wherein the first computing device is further configured to:
determine that a table within the source document exceeds a maximum chunk size; and
generate, based on the determination that the table exceeds the maximum chunk size, a plurality of table chunks, each table chunk of the plurality of table chunks including a subset of rows from the table and a replicated copy of one or more header rows from the table.

17. The system of claim 15, wherein the first computing device is further configured to:
determine, based on one or more document characteristics of the source document, a chunking policy from among a plurality of chunking policies; and
generate the plurality of chunks based on the chunking policy.

18. The system of claim 15, wherein the first computing device is further configured to:
generate, based on at least one chunk of the plurality of chunks, enrichment data comprising at least one of a summary, a title, one or more synonyms, or one or more domain-specific labels; and
cause the enrichment data to be associated with the at least one chunk.

19. The system of claim 15, wherein the associated metadata comprises at least one of a document identifier, a section identifier, a page range, an element type, a policy identifier, a version identifier, or an access-control label.

20. The system of claim 15, wherein the first computing device is further configured to:
determine, based on the structured representation, one or more structure-preservation constraints; and
generate the plurality of candidate chunk boundaries based on the one or more structure-preservation constraints, the one or more structure-preservation constraints comprising at least a size constraint and a constraint that avoids splitting the at least one structured element.
